(19) United States
(12) Patent Application Publication
(10) Pub. No.: US 2013/0192082 A1
(43) Pub. Date: Aug. 1, 2013

(54) Apparatus for and Method of Drying a Surface

(71) Applicant: Ronald Alexander (Scot) Young, Stourbridge (GB)

(72) Inventor: Ronald Alexander (Scot) Young, Stourbridge (GB)

(21) Appl. No.: 13/703,060

(22) PCT Filed: Jun. 13, 2011
(86) PCT No.: PCT/GB2011/051098

§ 371 Date: Apr. 8, 2013

(30) Foreign Application Priority Data
Jun. 11, 2010 (GB) 1009759.0

(51) Int. Cl. F26B 5/16

(52) U.S. Cl. CPC F26B 5/16
USPC 34/329; 34/95.1; 29/428

(57) ABSTRACT

A combination of a drying tool (10) and a cloth (22), and a method of attaching the cloth (22) to the drying tool (10). The drying tool (10) includes a head (12) having an upper side and a lower side, and a fitting (16) mounted on the head (12) for attaching a handle (14) to the head (12), the fitting (16) enabling pivotal movement of the head (12) relative to the handle (14), the method including providing an opening (24) in the cloth (22) for receiving at least one of a part of the fitting (16) and a part of the handle (14), positioning a region of the cloth (22) adjacent the upper side of the head (12) such that the at least one of the part of the fitting (16) and the part of the handle (14) is received in the opening (24) of the cloth (22), and positioning a portion of the cloth (22) adjacent the lower side of the head (12), so as to enable the portion of the cloth to contact a surface to be cleaned or dried.

### DESCRIPTION OF INVENTION

The present invention relates to an apparatus for and a method of drying a surface.

It is known to provide drying tools having a head with an upper side and a lower side, and a handle which is pivotable relative to the head. A cloth may be attached to the head to extend beneath the lower side thereof, such that moving the drying tool over a surface to be dried, for example a floor, brings the cloth into contact with liquid on the surface such that the cloth is able to absorb the liquid. The cloths of such drying tools are usually wrapped around the underside of the head, and held in place relative to the head with a pair of clips positioned on the upper side of the head.

A problem with such tools is that once the cloth has absorbed liquid, and become saturated, or substantially saturated, it is necessary to remove the cloth from the drying tool, and to replace the cloth with a dry cloth. Removal of the saturated cloth is both awkward, and can be unpleasant, as it is necessary to handle the saturated cloth to release the cloth from the clips.

According to a first aspect of the invention, there is provided a method of attaching a cloth to a drying tool, the drying tool including a head having an upper side and a lower side, and a fitting mounted on the head for attaching a handle to the head, the fitting enabling pivotal movement of the head relative to the handle, the method including providing an opening in the cloth for receiving at least one of a part of the fitting and a part of the handle, positioning a region of the cloth adjacent the upper side of the head such that the at least one of the part of the fitting and the part of the handle is received in the opening of the cloth, and positioning a further region of the cloth adjacent the lower side of the head, so as to enable the further region to contact a surface to be cleaned or dried.

Attaching the cloth to the tool in this manner is straightforward. Furthermore, the position of the cloth relative to the head can be adjusted without difficulty, and without the user having to handle wet and potentially soiled regions of the cloth.

The method may include selecting a co-efficient of friction between the lower side of the head and the cloth to be greater than a co-efficient of friction between the cloth and a surface to be dried. The advantage of this feature is that the region of the cloth to be used to dry the surface can be positioned beneath the head, and the relative position of that region of the cloth relative to the head will be retained during use of the tool, without the cloth having to be manually fixed to the head of the tool. However, the position of the cloth relative to the head is easily adjusted, without the need to detach the cloth from the drying tool, so as to position a relatively dry region of the cloth adjacent the lower side of the head, in order to enable continued drying of the surface, once the initial region of the cloth positioned adjacent the head has become saturated.

The method may include aligning the opening in the cloth with the handle of the drying tool, and sliding the cloth along the handle, towards the head, until a region of the cloth overlies the upper side of the head.

Alternatively, the method may include providing a slit which communicates with the opening in an edge of the cloth, placing the cloth adjacent the head, such that at least one of a part of the fitting and a part of the handle is receivable in the slit, and sliding the at least one of the part of the fitting and the part of the handle along the slit towards the opening in the cloth. This is advantageous in that the cloth can be fitted to the head quickly and straightforwardly, and it is not necessary to slide a wet cloth back along the handle to remove the cloth from the drying tool.

The method may include attaching a part of the cloth on one side of the slit to a part of the cloth on the opposite side of the slit. Where a slit is provided, closing the slit once the cloth is in position reduces the likelihood of the cloth slipping off the head inadvertently.

The method may include securing the cloth to the head of the drying tool. The method may include securing the cloth to the head by inserting a part of the cloth into a gripping formation. This inhibits the cloth from slipping out of the desired position relative to the head. The gripping portion is advantageously positioned on the upper side of the head, and therefore the part of the cloth which is received in the gripping portion, and which has to be removed from the gripping portion remains dry or relatively dry, even during use, because the part of the cloth which is gripped does not come into contact with the lower side of the head during use. Thus removal and replacement of the cloth from the drying tool need not involve manual handling of a wet part of the cloth.

According to a second aspect of the invention, there is provided a method of drying a surface including attaching a cloth to the head of a drying tool in accordance with the first aspect of the invention, moving the head of the drying tool across a surface to be dried, such that a first region of the cloth which is adjacent the lower side of the head absorbs liquid from the surface, and adjusting the position of the cloth relative to the head, such that a second region of the cloth which is positioned adjacent the lower side of the head includes a relatively dry region of the cloth.

The method may include maintaining the region of the cloth adjacent the upper side of the head substantially stationary relative to the upper side of the head. This is advantageous because the part of the cloth which is handled by the user to attach the cloth to the drying tool, and to remove the cloth from the drying tool, remains dry or substantially dry, even during use of the cloth, because this region of the cloth remains out of contact with the surface to be dried.

The method may include moving the head out of contact with the first region of the cloth adjacent the lower side of the head, and adjusting the position of the cloth relative to the lower side of the head, and moving the head into contact with the second region of the cloth. This may be done without the user having to touch the cloth with his/her hands.

The method may include moving the head out of contact with the first region of the cloth and moving the head into contact with the second region of the cloth include lifting and lowering the head, respectively.

According to a third aspect of the invention, there is provided a combination of a drying tool and a cloth for drying a surface, the drying tool including a head having an upper side and a lower side, and a fitting for attaching a handle to the head, the fitting enabling pivotal movement of the handle relative to the head, the lower side of the head including a holder for a drying member, the cloth including an opening to receive at least one of a part of a fitting for the handle and a part of the handle, such that a region of the cloth overlies the upper side of the head, and another region of the cloth is positioned adjacent the lower side of the head.

The holder may be a channel in which an elongate drying member is receiveabie, for example the drying tool may be a squeegee. The drying member may be held in a substantially U-shaped configuration by the holder and present two edges to the surface to be dried. The drying tool may advantageously be used to partially dry a surface to be dried, for example by moving a proportion of the liquid on the surface to a drainage point, before attaching the cloth to the head, and absorbing any remaining liquid with the cloth.

The drying tool may include a pair of holders, for holding respective drying members. Such a “double-squeegee” is particularly advantageous in holding the cloth in position relative to the head. The lower side of the head presents a greater surface area to the surface to be dried, and a larger region of cloth can thus be positioned beneath the head, than with a single drying member.

The drying tool may include one or more gripping formations for securing a region of the cloth in position relative to the upper side of the head. The or each gripping formation may be formed by the pair of holders, the holders being resilient, such that the size of a space between the holders is adjustable to receive and grip a portion of the cloth. Providing the gripping formation(s) in this way means that no additional parts are required.

Alternatively or additionally, the or each gripping formation may include a body including an opening for receiving a part of the cloth, and at least one resiliently deformable formation for holding the part of the cloth in position relative to the body.

The cloth may include a slit which extends from the opening to an edge of the cloth, to enable the cloth to be positioned adjacent the upper side of the head without having to slide the cloth along the handle of the drying tool.

The cloth may include a closure for attaching a part of the cloth on one side of the slit to a part of the cloth on the opposite side of the slit.

The closure may be a hook and loop closure.

Embodiments of the invention will now be described, by way of example only, with reference to the accompanying drawings, of which:

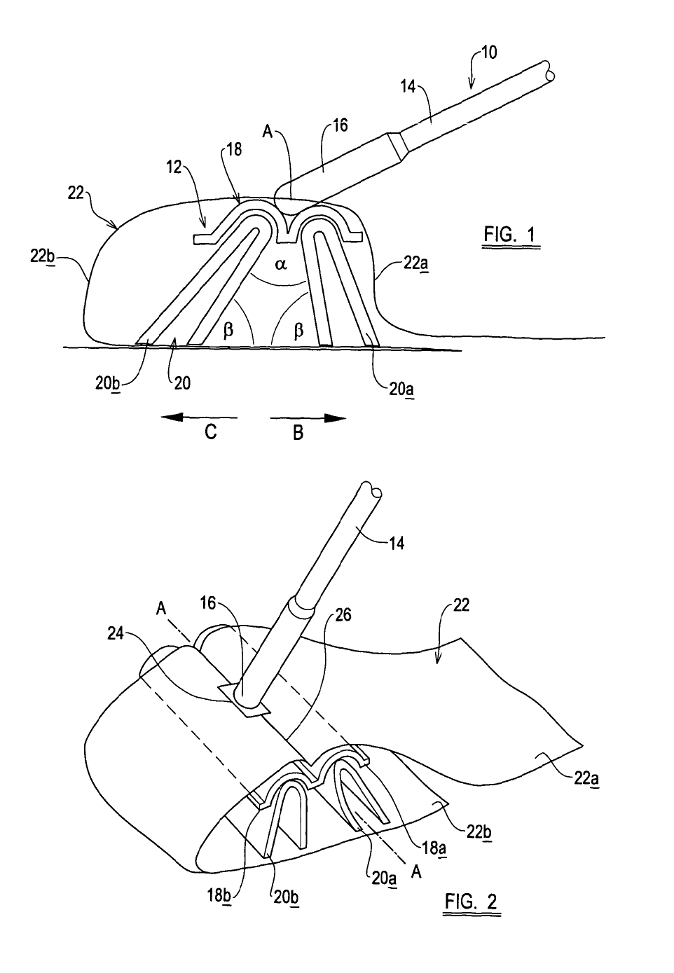

FIG. 1 is an illustrative side view of a combination of a drying tool and a cloth in accordance with one aspect of the invention;

FIG. 2 is a perspective view of the combination of FIG. 1;

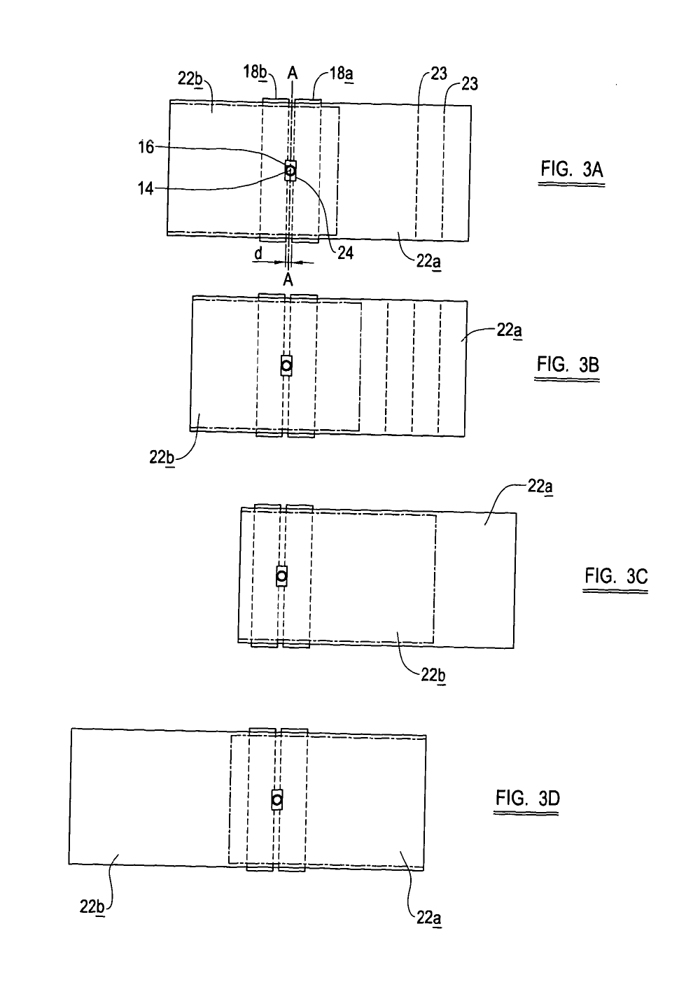

FIGS. 3A to 3D are plan views of the combination of FIG. 1, showing the cloth in different configurations relative to a head of the drying tool;

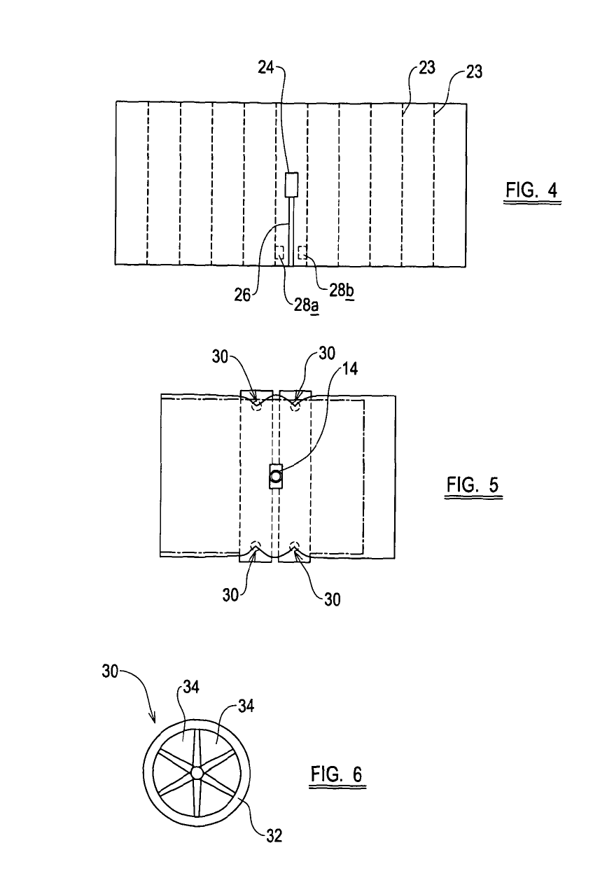

FIG. 4 is a plan view of an example of a cloth which is suitable for combining with a drying tool as shown in FIG. 1.

FIG. 5 is a plan view of an alternative embodiment of the drying tool, including gripping formations for gripping the cloth; and

FIG. 6 is an enlarged plan view of a gripping formation of the drying tool shown in FIG. 5.

Referring to the figures, there is shown a drying tool 10, for drying a floor, including a head 12, having an upper side and a lower side, and a handle 14. The handle 14 is an elongate pole which is attached to the head 12 by a fitting 16, which is positioned on the upper side of the head 12, and which fitting 16 permits pivotal movement of the handle 14 relative to the head 12 about an axis A which, in use, is substantially horizontal. The fitting 16 may alternatively be a universal joint, which permits pivotal movement of the head about the axis A, and rotation of the handle 14 about an axis which is transverse to the axis A.

The head 12 includes a pair of holders 18a, 18b, which hold respective drying members 20a, 20b. In this example, each drying member 20a, 20b is a sheet of resilient material, for example rubber or neoprene, folded into a substantially C-shaped configuration. Each holder 18a, 18b is a channel which grips the respective drying element 20a, 20b, at a position which is approximately mid-way between the two edges of the drying member 20a, 20b, such that the edges of each drying element 20a, 20b are free and form a pair of substantially parallel blades, which extend from the lower side of the head 12. However, it will be appreciated that each drying member 20a, 20b could alternatively be a single blade or block which is not folded into a substantially C-shaped configuration.

The holders 18a, 18b are adjacent and substantially parallel to one another, and are connected to one another at one or more points, such that a small or negligible space is provided between the holders 18a, 18b, at one or more points along the upper side of the head 12. The holders 18a, 18b are deformable, such that the width (d) of the space(s) is manually adjustable, as will be described in greater detail below.

An angle α of between approximately 30° and approximately 60° is subtended between the holders 18a, 18b, such that each drying member 20a, 20b subtends an angle β of between approximately 30° and 75° to the surface to be dried. However, in use, the two drying members do not subtend the same angle β to the surface to be dried, as explained in more detail below.

The holders 18a, 18b are preferably connected together at or near to the mid-point of the axis A, which is where the fitting 16 is positioned. The fitting 16 is attached to an upper part of the holders 18a, 18b, for example by means of a plate attached to the holders 18a, 18b, or alternatively may be attached between the holders 18a, 18b.

A cloth 22 is provided in combination with the drying tool 10, and is attachable thereto. The cloth 22 is substantially rectangular, although it will be appreciated that other shapes would be suitable for differently shaped heads 10.

The cloth 22 includes an opening 24 for receiving a part of the fitting 16 and/or a part of the handle 14. In the example shown in the drawings, the opening 24 is rectangular, however, the opening may be any shape, and may be selected to match the shape of the fitting 16. The opening 24 may be a slit which is enlargeable, so as to provide an opening of an appropriate size and shape for the fitting and/or handle of the drying tool 10.

The opening 24 is preferably positioned substantially centrally in the cloth 22, to accommodate a handle 14 and or fitting 16 which is positioned in the centre of the head 12 of the drying tool 10. A first portion 22a of the cloth 22 extends from the upper side of the head 12 in a direction (shown by the arrow E) which is generally transverse to the direction in which the channels 18a, 18b extend, and a second portion 22b of the cloth 22 extends in a second direction (shown by the arrow C) which is also substantially transverse to the direction in which the channels 18a, 18b extend, and is opposite to the first direction.

This example of the cloth 22 also includes a slit 26 (as shown clearly in FIG. 4) which extends from the opening 24 to an edge of the cloth 22. The cloth 22 also includes one or more closures 28 to hold the parts of the cloth 22 on opposite sides of the slit 26 together. In the present example, the or each closure 28 includes a hook and loop fastener, wherein one of a hook portion 28a and a loop portion 28b of the fastener is attached to an upper side of the cloth 22 on one side of the slit, and the other of the hook portion 28a and the loop portion 28b of the fastener is attached to a lower side of the cloth 22 on the opposite side of the slit. Alternative forms of closure are possible. It will be appreciated that the slit 26 and/or the closures 28 are optional, and may be omitted.

The cloth 22 includes a plurality of gradations 23, which are indicated by lines, for example, which extend laterally across the cloth 22, preferably from one side of the cloth 22, to the other. This feature is also optional.

The cloth 22 is preferably manufactured from a synthetic material, for example a microfibre fabric. The cloth preferably has a ‘waffle’ texture.

The drying tool 10 is provided with one or more gripping formations for receiving and gripping a portion of the cloth 22. Where the holders 18a, 18b are spaced apart, as described above, the or each gripping formation is formed by the or each space between the holders 18a, 18b. A part of the cloth 22 is receivable in the or each space between the holders.

In use, the cloth 22 is positioned over the head 12 of the drying tool 10, such that the handle 14 is received in the opening 24. The cloth 22 is positioned adjacent the upper side of the head 12, such that at least a part of the fitting 16 and/or a part of the handle 14 is received in the slit 26. The cloth 22 is then moved relative to the head such that the fitting 16 and/or the part of the handle moves along the slit 26, towards the opening 24, until the opening 24 surrounds a part of the fitting 16 and/or a part of the handle 14. Where provided, the or each closure 28 is closed, so as to inhibit the fitting 16 from moving back along the slit 26 towards the edge of the cloth 22, thus inhibiting lateral movement of the cloth 22 relative to the head 12.

A region of the cloth 22 overlies the upper side of the head 12, and the first and second portions 22a, 22b of the cloth 22 extend in opposite directions away from the handle 14. One of the first and second portions 22a, 22b is folded beneath the lower side of the head 12, such that a first region of the cloth is permitted to come into contact with a surface to be dried. In FIGS. 1 and 2, the portion 22b is shown in this configuration. The other of the first and second portions 22a, 22b (22a in the example shown in FIGS. 1 and 2) trails the head 12 of the drying tool 10, and the respective lengths of the portions 22a, 22b are such that a part of the trailing portion 22a overlies a part of the portion 22b folded under the head 12.

As shown in FIG. 1 and FIG. 3A, the head 12 is initially placed in contact with the portion 22b of the cloth 22 towards the free end of the portion 22b, such that the majority of the portion 22b of the cloth 22 extends in a loop towards the front of the head 12. One of the drying members 20a, 20b is oriented substantially perpendicular to the surface to be dried, such that the other drying member is elevated through angle α, which tends to hold the trailing portion 22a, 22b of the cloth 22 up and away from the surface to be dried and the other portion 22a, 22b of the cloth 22.

The combination of the drying tool 10 and the cloth 22 is then manoeuvrable across a surface to be dried, such that the cloth 22 absorbs liquid from the surface. The co-efficient of friction between the cloth 22 and the drying elements 20 is selected to be greater than the co-efficient of friction between the cloth 22 and the surface to be dried. It is preferable that during movement of the combination of the drying tool 10 and the cloth 22 across the surface to be dried, the friction between the cloth and the drying element 20 will be “static”, i.e. permitting substantially no relative movement, whilst the friction between the cloth 22 and the surface to be dried will be “kinetic”, i.e. permitting relative movement. Thus, the region of the cloth 22 which is adjacent the upper side of the head 12 remains substantially stationary relative to the head 12 during movement of the drying tool 10 across the surface to be dried.

When the first region of the cloth 22 adjacent the lower side of the head 12 becomes saturated, it is necessary to adjust the position of the cloth 22 relative to the head 12, such that a drier region of the cloth 22 underlies the head 12, to enable the drying operation to be continued.

In order to move the cloth 22, it is necessary to take the cloth 22 out of contact with the lower side of the head 12. This may be done by holding the cloth 22 stationary relative to the surface to be dried, and then lifting the head 12 away from the cloth 22, before moving the head 12 longitudinally relative to the cloth, such that a new region of the cloth 22 is positioned beneath the head 12. The new region of cloth adjacent the lower side of the head 12 may include a part of the first region of the cloth which was adjacent the lower side of the head 12.

As shown in FIGS. 3A to 3D, the head 12 of the drying tool is moved away from the free end of the portion 22b of the cloth, such that the amount of the portion 22b of the cloth 22 which underlies the “trailing” portion 22a of the cloth increases. The distance through which the head 12 is moved relative to the cloth 22 may be equal to the width of the head, such that a substantially dry region of the portion 22b underlies the head 12. Alternatively, the distance moved by the head 12 relative to the cloth 22 may be a proportion of width of the head 12, such that the region underlying the head 12 includes a part of a region which has previously been in contact with the head, and a “fresh” part which has not previously been in contact with the lower side of the head 12. The gradations 23 provided on the cloth 22 may be used to indicate how far to move the cloth 22 relative to the head 12.

The head 12 is then lowered towards the cloth 22 to come into contact with the new region of the cloth 22. The user is able to hold the cloth 22 stationary relative to the surface to be cleaned with his or her foot, for example, rather than having to touch the cloth 22 with his or her hands (although it will be appreciated that this is also possible). This reduces the requirement for the user to bend down, to manually adjust the position of the cloth 22 relative to the head 12.

When the portion 22b has been exhausted, i.e. the portion 22b is wrapped relatively tightly around the head 12, as shown in FIG. 3C, such that the cloth 22 does not form a loop towards the front of the head 12, the portion 22a may be used to dry the surface. It will be appreciated that the head 12 may be moved in the opposite direction relative to the cloth 22, such that the cloth 22 is wrapped gradually less tightly around the head 12. The user lifts the head 12 of the drying tool, 10 away from the cloth 22, whilst holding the cloth 22 stationary relative to the surface to be dried, such that the portions 22a, 22b of the cloth hang down on either side of the head 12. The portion 22a is then positioned beneath the lower side of the head 12, with the portion 22b overlying a region of the portion 22a, and the head 12 is lowered towards the surface to be dried. This configuration is shown in FIG. 3D.

When the region of the portion 22a which underlies the head 12 is saturated and needs to be replaced, the user repeats the steps set out above in relation to portion 22b, to present a new region of the portion 22a beneath the head 12.

When substantially all of the cloth 22 has been saturated, the cloth 22 is removed from the drying tool 10, by opening the closures 28 (where provided), and moving the cloth in a lateral direction relative to the head 12, such that the handle 14 and/or the fitting 16 passes along the slit 26, towards an edge of the cloth 22. The cloth 22 is preferably turned over, such that the other side of the cloth 22 can be used in the manner described above. The cloth 22 is then cleaned and/or dried for reuse, or is disposed of. A replacement cloth 22 is attachable to the drying tool 10 in the manner described above.

It will be appreciated that since the drying tool 10 includes a drying element 20, the drying tool 10 is usable in a first drying operation, for example to accumulate liquid in a particular region of the surface to be dried. The cloth 22 is then attachable to the tool 10, to absorb the accumulated liquid.

It will also be appreciated that a plurality of different types of cloth 22 may be provided, for use with different surfaces, and/or for carrying out different drying tasks. For example, the cloths may provide different coefficients of friction, so as to ensure that the friction between the cloth and the surface is always greater than that between the cloth and the surface to be dried. The cloths may additionally or alternatively have different absorbencies. For example, a first cloth may be used to remove the majority of the liquid from a surface, but leaving an amount of liquid behind. A second cloth of a lower absorbency may then be used to remove the remaining liquid or moisture from the surface.

Different portions of the cloth may exhibit different properties. For example, the first portion 22a may provide a different absorbency and/or co-efficient of friction from the second portion 22b.

Whilst the cloth 22 shown in the drawings and described herein show the first portion 22a and the second port of the cloth 22 as being approximately the same length, i.e. with the opening 24 positioned centrally, lengthwise in the cloth 22, the opening 24 may alternatively be positioned towards one end of the cloth 22.

Alternative embodiments of the drying tool and the cloth are anticipated. The drying tool need only have a single holder 18 and a single drying element 20. In this example, the fixing 16 is attached to an upper part of the holder 18 for pivotal and/or rotational movement relative thereto. This embodiment of the invention is optionally provided with one or more gripping formations 30 to hold the cloth 22 in position relative to the head 12 of the drying tool 10.

It will be appreciated, that whilst the coefficient of friction provided between the drying member(s) 20 and the cloth 22 is advantageously high, it may be possible to omit or remove the drying members 20 from the drying tool 10, such that the cloth is positioned directly adjacent the lower side of the head 12.

The fitting 16 is shown attached to the upper side of the head 12. The fitting 16 may be carried by the head 12 or the handle 14, provided that the fitting is able to permit movement of the handle 14 relative to the head 12. The fitting 16 need not be connected to the upper side of the head 12, it may be connected to a lower side of the head, 12, there being an opening or space in the head which is able to receive at least a part of one of the fitting 16 and the handle 14, to permit movement of the handle relative to the head 12. A mount may be attached to a part of the head 12 to carry the fitting 16.

The cloth 22 need not be provided with closures 28, for closing the slit 26. The coefficient of friction between the portions of cloth 22 on either side of the slit may be sufficient to enable the portions of the cloth 22 on opposite sides of the slit 26 to stick to one another, thus temporarily closing the slit 26.

The cloth 22 need not be provided with a slit 26, and may only be provided with an opening 24. In this example, to position the cloth 22 relative to the drying tool, the opening 24 is aligned with the handle 14 and the cloth 22 is slid down the handle 14 towards the head 12, until a part of the cloth 22 overlies the upper side of the head 12.

A second embodiment of gripping formation may be provided additionally or alternatively to the space(s) between the drying element holders 18. The second embodiment of the gripping formation 30 includes a body 32, which, in this example is substantially circular. The body 32 includes an opening which is at least partially covered by a plurality of resiliently deformable projections 34, which extend from an outer edge of the body 32 towards the centre of the body 32, and co-operate with one another so as to enable a portion of the cloth 22 to be received in the body 32, and to hold the portion of cloth 22 in place relative to the body 32. In the example shown in FIG. 5, four such gripping formations are provided. However, it will be appreciated that any number of such gripping formations may be provided, and that the provision of such gripping formations is optional. The or each such gripping formation 30 is positioned on an upper part of the or each holder 18.

The drying tool 10 may be substituted for a drying tool for drying surfaces other than floors, and may be adapted to be suitable for other applications, for example, the handle may be short, and not pivotable relative to the head 12, for example to provide a drying tool which is suitable for drying windows, etc.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of attaching a cloth to a drying tool, the drying tool including a head having an upper side and a lower side, and a fitting mounted on the head for attaching a handle to the head, the fitting enabling pivotal movement of the head relative to the handle, the method including providing an opening in the cloth for receiving at least one of a part of the fitting and a part of the handle, positioning a first region of the cloth adjacent the upper side of the head such that the at least one of the part of the fitting and the part of the handle is received in the opening of the cloth, and positioning a second region of the cloth adjacent the lower side of the head, so as to enable the second region to contact a surface to be cleaned or dried, wherein the lower side of the head of the drying tool includes a squeegee and the first region of the cloth is towards a first free end of the cloth and the second region of the cloth is towards a second free end of the cloth.

2. A method according to claim 1 including selecting a co-efficient of friction between the lower side of the head and the cloth to be greater than a co-efficient of friction between the cloth and a surface to be dried.

3. A method according to claim 1 including aligning the opening in the cloth with the handle of the drying tool, and sliding the cloth along the handle, towards the head, until a region of the cloth overlies the upper side of the head.

4. A method according to claim 1 including providing a slit which communicates with the opening in an edge of the cloth, placing the cloth adjacent the head, such that at least one of a part of the fitting and a part of the handle is receivable in the slit, and sliding the at least one of the part of the fitting and the part of the handle along the slit towards the opening in the cloth.

5. A method according to claim 4 including attaching a part of the cloth on one side of the slit to a part of the cloth on the opposite side of the slit.

6. A method according to claim 1 including securing the cloth to the head of the drying tool.

7. A method according to claim 6 including securing the cloth to the head by inserting a part of the cloth into a gripping formation.

8. (canceled)

9. A method of drying a surface including attaching a cloth to the head of a drying tool in accordance with the method of claim 1 including moving the head of the drying tool across a surface to be dried, such that a first part of the first region of the cloth which is adjacent the lower side of the head absorbs liquid from the surface, and adjusting the position of the cloth relative to the head, such that a second part of the first region of the cloth which is positioned adjacent the lower side of the head includes a relatively dry region of the cloth.

10. A method according to claim 9 wherein the second region of the cloth remains substantially stationary relative to the upper side of the head.

11. A method according to claim 9 including moving the head out of contact with the first part of the first region of the cloth adjacent the lower side of the head, and adjusting the position of the cloth relative to the lower side of the head, and moving the head into contact with the second part of the first region of the cloth.

12. A method according to claim 11 wherein moving the head out of contact with the first part of the first region of the cloth and moving the head into contact with the second part of the first region of the cloth include lifting and lowering the head, respectively.

13. (canceled)

14. A combination of a drying tool and a cloth for drying a surface, the drying tool including a head having an upper side and a lower side, and a fitting for attaching a handle to the head, the fitting enabling pivotal movement of the handle relative to the head, the lower side of the head including a holder for a drying member, the cloth including an opening to receive at least one of a part of a fitting for the handle and a part of the handle, such that a first region of the cloth overlies the upper side of the head, and a second region of the cloth is positioned adjacent the lower side of the head, wherein the lower side of the head of the dr ins tool includes a squeegee and the first region of the cloth is towards a first free end of the cloth and the second region of the cloth is towards a second free end of the cloth.

15. A combination according to claim 14 wherein the holder is a channel in which an elongate drying member is receivable.

16. A combination according to claim 15 wherein the drying member is a sheet of material, which is held in a substantially U-shaped configuration by the holder so as to present two edges to the surface to be dried.

17. A combination according to claim 15 wherein the drying tool includes a pair of holders, for holding respective sheets of material in substantially U-shaped configurations.

18. A combination according to claim 14 wherein the drying tool includes one or more gripping formations for securing a region of the cloth in position relative to the upper side of the head.

19. A combination according to claim 18, wherein the or each gripping formation is formed by the pair of holders, the holders being resilient, such that the size of a space between the holders is adjustable to receive and grip a portion of the cloth.

20. A combination according to claim 18 wherein the or each gripping formation includes a body including an opening for receiving a part of the cloth, and at least one resiliently deformable formation for holding the part of the cloth in position relative to the body.

21. A combination according to claim 14 wherein the cloth includes a slit which extends from the opening to an edge of the cloth, and a closure for attaching a part of the cloth on one side of the slit to a part of the cloth on the opposite side of the slit.

22. (canceled)

23. A combination according to claim 21, wherein the closure is a hook and loop closure.

24. (canceled)

25. (canceled)
